(19) United States
(12) Patent Application Publication
(10) Pub. No.: US 2011/0157147 A1
(43) Pub. Date: Jun. 30, 2011

(54) DRIVING DEVICE OF LIGHT EMITTING UNIT

(75) Inventor: Tsung-Ting Tsai, Tainan City (TW)

(73) Assignee: AU OPTRONICS CORPORATION, Hsinchu (TW)

(21) Appl. No.: 12/729,241

(22) Filed: Mar. 23, 2010

(30) Foreign Application Priority Data
Dec. 29, 2009 (TW) 98145636

(51) Int. Cl. G06F 3/038

(52) U.S. Cl. 345/213

(57) ABSTRACT

A driving device of a light emitting unit is provided, which includes a driving circuit, a memory unit, a reset circuit, a first switch and a compensation circuit. The driving circuit determines a driving current according to a voltage of a control node. The memory unit maintains a voltage of the control node of the driving circuit. The reset circuit provides a reset voltage to the control node of the driving circuit during a reset period. A first node of the first switch receives a data voltage, and the control node of the first switch receives a scan voltage. The compensation circuit is connected between a second node of the first switch and the control node of the driving circuit to transmit the data voltage provided by the first switch to the control node of the driving circuit.

### CROSS-REFERENCE TO RELATED APPLICATION

This application claims the priority benefit of Taiwan application serial no. 98145636, filed on Dec. 29, 2009. The entirety of the above-mentioned patent application is hereby incorporated by reference herein and made a part of specification.

### BACKGROUND OF THE INVENTION

1. Field of the Invention

The invention generally relates to a driving device of a light emitting unit, and more particularly, to a driving device adapted for a light emitting unit of a pixel circuit.

2. Description of Related Art

The information and communication industries have become indispensable in our society thanks to the focused development of various communication and display products, such as portable communication and display devices as well as home televisions and display panels. Since a flat panel display (FPD) provides an interface for information exchange, its development is especially important.

The following techniques are currently applied to the FPD: liquid crystal display (LCD), electro-luminescence display, light emitting diode (LED), organic light emitting diode (OLED), plasma display panel (PDP), vacuum fluorescent display, and field emission display (FED). Compared with other FPD techniques, an organic electro-luminescence display panel has a tremendous application potential to become a mainstream next generation FPDs due to its advantages of self-luminescence, no viewing-angle dependence, power savings, simple manufacturing process, low cost, low working temperature, high response speed, and full-color display.

In display panels adopting conventional techniques, LEDs or OLEDs are typically used as the light emitting units of the pixels in the display panels. Usually, a circuit configuration having two transistors and a capacitor (i.e., 2T1C) is employed to drive the aforementioned light emitting units. In the above-described 2T1C driving circuit configuration, an equation for generating a driving current has parameters such as a power source voltage and a transistor threshold voltage. Therefore, the power source voltage received by each of the pixel circuits must be close to the transistor threshold voltage, so the same driving current may be obtained under identical data voltages.

Nowadays, as the display panel increases in size, a circuit line of the power source voltage received by each of the pixel circuits is accordingly lengthened. Consequently, as the circuit line lengthens, an equivalent impedance therein increases, such that the power source voltage received by each of the driving circuits is not the same due to the equivalent impedance in the circuit line and a voltage drop size, thereby the driving circuits produce dissimilar currents. Under the same data voltage, the brightness of each of the pixel circuits varies minutely, resulting in a non-uniform brightness on the display panel. Moreover, the 2T1C driving circuit configuration produces different driving currents due to a variation of the transistor threshold currents. Therefore, as the display panel increases in size, how to mitigate the above-described issue has become a pertinent subject of research.

### SUMMARY OF THE INVENTION

An aspect of the invention provides a driving device of a light emitting unit, such that a driving current produced by the light emitting unit is not affected by a transistor threshold voltage. Thereby, the light emitting unit may achieve an uniform brightness for each of the pixels on a display panel in accordance with a same data voltage.

An aspect of the invention provides a driving device of a light emitting, including a driving circuit, a memory unit, a reset circuit, a first switch, and a compensation circuit. The driving circuit has a control node and a drive node, with the drive node connected to a light emitting unit, and the driving circuit determines a current of the control node according to a voltage of the control node. The memory unit is connected to the control node of the driving circuit, so as to maintain the voltage of the control node of the driving circuit. The reset circuit is connected to the control node of the driving circuit, and the reset circuit provides a reset voltage to the control node of the driving circuit during a reset period. The first switch has a first node receiving a data voltage and a control node receiving a scan voltage. The compensation circuit is connected between a second node of the first switch and the control node of the driving circuit, so as to transmit the data voltage provided by the first switch to the control node of the driving circuit.

In one embodiment of the invention, the aforesaid reset circuit does not provide the reset voltage outside of the reset period. The reset voltage may be a power source voltage.

In one embodiment of the invention, the aforesaid first switch includes a first transistor having a first node receiving the data voltage, a second node connected to the compensation circuit, and a control node receiving the scan voltage.

In one embodiment of the invention, the aforesaid driving circuit includes a second transistor having a first node receiving a first voltage, a second node configured as the drive node of the driving circuit, and a control node configured as the control node of the driving circuit.

In one embodiment of the invention, the aforesaid compensation circuit includes a third transistor having a first node connected to the second node of the first switch, a second node connected to the control node of the driving circuit, and a control node connected to the second node of the third transistor.

In one embodiment of the invention, the aforesaid compensation circuit includes a diode having a cathode connected to the second node of the first switch, and an anode connected to the control node of the driving circuit.

In one embodiment of the invention, the aforesaid reset circuit includes a second switch having a first node connected to a power source voltage, a second node connected to the control node of the driving circuit, and a control node connected to a previous scan voltage. Here, the second switch includes a fourth transistor having a first node connected to the power source voltage, a second node connected to the control node of the driving circuit, and a control node receiving the previous scan voltage.

In one embodiment of the invention, the aforesaid memory unit includes a capacitor having a first node connected to the control node of the driving circuit, and a second node receiving a third voltage. Here, the third voltage may be the power source voltage or the ground voltage.

In summary, an embodiment of the invention employs in advance a reset circuit to reset a control node voltage of a driving circuit, then employs a compensation circuit to transmit a data voltage to the control node of the driving circuit. Moreover, a capacitor is employed to maintain the value of the control node voltage of the driving circuit, such that the driving current produced by the driving circuit is solely correlated with the data voltage and not influenced by a transistor threshold voltage. Thereby, according to substantially equal data voltages, a light emitting unit may achieve an uniform brightness for each of the pixels on a display panel.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an circuit diagram of a driving device of a light emitting unit in accordance with a first embodiment of the invention.

FIG. 2 is a drive timing diagram of the driving device of the light emitting unit depicted in FIG. 1 in accordance with the first embodiment of the invention.

FIG. 3 is a characteristic curve of a driving current and a data voltage of the light emitting unit depicted in FIG. 1 in accordance with the first embodiment of the invention.

FIG. 4 is a circuit diagram of a driving device of a light emitting unit in accordance with a second embodiment of the invention.

FIG. 5 is a circuit diagram of a driving device of a light emitting unit in accordance with a third embodiment of the invention.

FIG. 6 is a circuit diagram of a driving device of a light emitting unit in accordance with a fourth embodiment of the invention.

FIG. 7 is a circuit diagram of a driving device of a light emitting unit in accordance with a fifth embodiment of the invention.

FIG. 8 is a drive timing diagram of the driving device of the light emitting unit depicted in FIG. 7 in accordance with the fifth embodiment of the invention.

### DESCRIPTION OF EMBODIMENTS

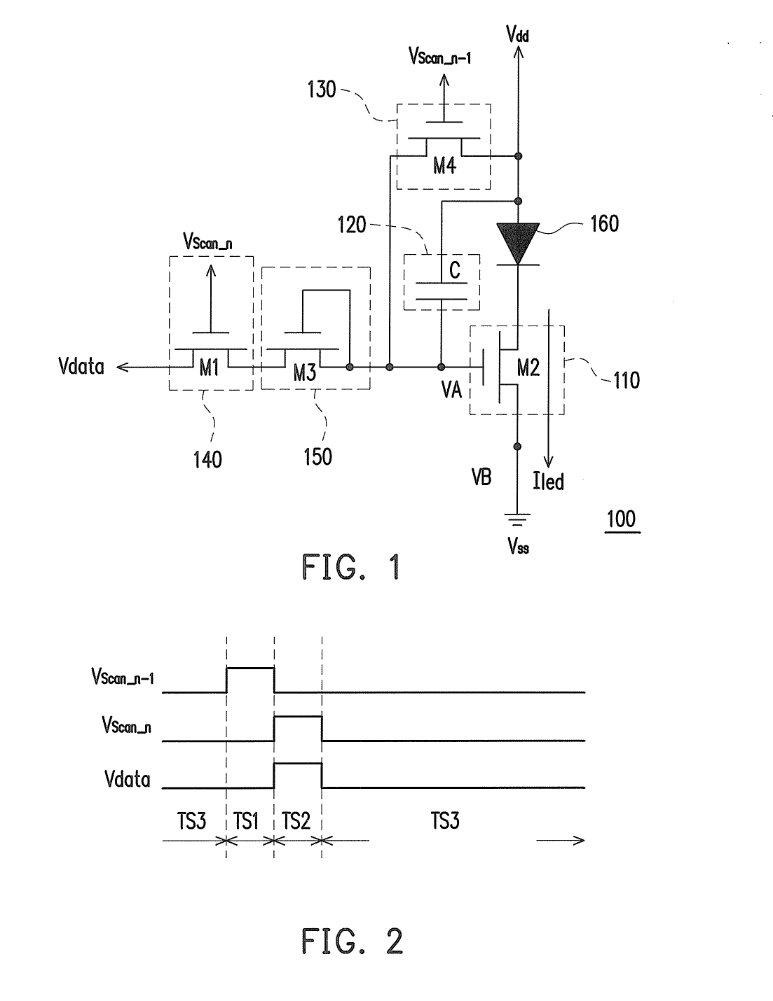

To further explain the spirit of the invention to persons of ordinary knowledge in this art, several embodiments are detailed in the following paragraphs by using a light emitting unit and a driving device to implement a pixel circuit in a display panel. Referring to FIG. 1, FIG. 1 is an equivalent circuit diagram of a driving device 100 of a light emitting unit 160 in accordance with a first embodiment of the invention. The driving device 100 of the light emitting unit 160 includes a driving circuit 110, a memory unit 120, a reset circuit 130, a first switch 140, and a compensation circuit 150. The driving circuit 110 has a control node and a drive node, and the drive node is connected to the light emitting unit 160. The driving circuit 110 determines a driving current Iled of the control node according to a control node voltage VA.

The memory unit 120 is connected to the control node of the driving circuit 110, so as to maintain the control node voltage VA of the driving circuit 110. The reset circuit 130 is connected to the control node of the driving circuit 110, so as to provide a reset voltage to the control node of the driving circuit 110 during a reset period, and to discontinue providing the reset voltage outside of the reset period. The first switch 140 has a first node 140 receiving a data voltage Vdata and a control node receiving a scan voltage Vscan_n. The compensation circuit 150 is connected between a second node of the first switch 140 and the control node of the driving circuit 110, so as to transmit a threshold voltage and the data voltage Vdata provided by the first switch 140 to the control node of the driving circuit 110.

In the present embodiment of the invention, the light emitting unit 160 may be a light emitting diode (LED), an organic light emitting diode (OLED), or other current controlled light emitting devices. The light emitting unit 160 receives the driving current Iled to emit light, and a size of the driving current Iled is related to a brightness of the light emitting unit 160. As the driving current Iled increases in size, the light emitting unit 160 becomes brighter.

In the present embodiment of the invention, the first switch 140 includes a first transistor M1 that is a N-channel metal oxide semiconductor (NMOS) transistor, for example. The first transistor M1 has a first node (e.g., a source node) receiving the data voltage Vdata, a second node (e.g., a drain node) connected to the compensation circuit 150, and a control node (e.g., a gate node) receiving the scan voltage Vscan_n. In other embodiments of the invention, the first switch 140 may be replaced by a switching circuit having a same functionality, and the first switch 140 is not limited to a single transistor. A user of the present embodiment may adjust the first switch 140 according to a design requirement.

In the present embodiment, the driving circuit 110 includes a second transistor M2 that is a NMOS transistor, for example. The first transistor M2 has a first node (e.g., a source node) receiving a first voltage, a second node (e.g., a drain node) that is the drive node of the driving circuit 110, and a control node (e.g., a gate node) that is the control node of the driving circuit 110. In the present embodiment of the invention, the first voltage is a ground voltage Vss. In other embodiments of the invention, the first voltage may be a power source voltage Vdd. The driving circuit 110 may also be implemented by a current mirror circuit or by P-channel metal oxide semiconductor (PMOS) transistors, and a user of the present embodiment may adjust according to a design requirement. The memory unit 120 includes a capacitor C, configured to maintain the control node voltage VA of the driving circuit 110. The capacitor C has a first node connected to the control node of the driving circuit 110 and a second node receiving a third voltage. In the present embodiment, the third voltage may be the power source voltage Vdd.

The compensation circuit 150 includes a third transistor M3 that is a NMOS transistor in the present embodiment, for example. The third transistor M3 has a first node (e.g., a source node) connected to the second node of the first switch 140, a second node (e.g., a drain node) connected to the control node of the driving circuit 110, and a control node (e.g., a gate node) connected to the second node of the third transistor M3. Therefore, the third transistor M3 acts as a diode having an anode connected to the control node of the driving circuit 110, and a cathode connected to the second node of the first switch 140.

In the present embodiment, the reset circuit 130 includes a second switch formed by a fourth transistor M4 that is a NMOS transistor, for example. The fourth transistor M4 has a first node (e.g., a drain node) connected to a second voltage (e.g., the power source voltage Vdd), a second node (e.g., a source node) connected to the control node of the driving circuit 110, and a control node (e.g., a gate node) receiving a previous scan voltage Vscan_n−1. Herein, the second switch may be replaced by a circuit having a same functionality, and the second switch is not limited to a single transistor. A user of the present embodiment may adjust the second switch according to a design requirement.

The previous scan voltage Vscan_n−1 is boosted in advance of the scan voltage Vscan_n being boosted to the high level, such that the second switch in the reset circuit 130 is turned on. Moreover, the reset circuit can thereby provide the reset voltage (i.e., the power source voltage Vdd in the present embodiment) to the control node of the driving circuit 110 and the first node of the capacitor C during the reset period (i.e., before the first switch 140 is turned on). It should be noted that, if the scan voltage Vscan_n is a driving signal of a nth scan line in a pixel array, then the previous scan voltage Vscan_n−1 may be a scanning signal of a n−1th scan line, or may also be driving signal of an previously triggered scan line (e.g., a n−2th scan line, a n−3th scan line, etc.) The high and low voltage levels of the scan voltage Vscan_n and the previous scan voltage Vscan_n−1 may be respectively set according to a design requirement. For example, the high voltage level of the scan voltage Vscan_n and the previous scan voltage Vscan_n−1 of the present embodiment is substantially equal to the power source voltage Vdd, and the low voltage level is substantially equal to 0 V. Accordingly, a turn on period and a turn off period of the first switch 140 or the second switch of the reset circuit 130 may be controlled. A scan voltage adopted in a conventional 2T1C pixel circuit configuration may be used as the scan voltage Vscan_n, so that time spent on designing a drive timing sequence is saved.

The operation of the driving circuit 100 for the light emitting unit 160 according to the first embodiment is described hereinafter, with reference to both FIGS. 1 and 2. FIG. 2 is a drive timing diagram of the driving device 100 depicted in FIG. 1 in accordance with the first embodiment of the invention. Hereafter the source node of the second transistor M2 is referred to as VB. In the present embodiment of the invention, a driving sequence is divided into three periods: a reset period TS1, a scan period TS2, and a latch period TS3. During the reset period TS1, before the scan voltage Vscan_n is converted from a low voltage level to a high level voltage (i.e. Vscan_n currently at the low voltage level), the previous scan voltage Vscan_n−1 is converted in advance from the low voltage level to the high voltage level. Therefore, the first switch 140 is in a turn off state, whereas the second switch in the reset circuit 130 is in a turn on state. Accordingly, the reset circuit 130 resets the control node voltage VA of the driving circuit 110 to the power source voltage Vdd, and the capacitor C in the memory unit 120 is reset as well. A source node voltage VB of the second transistor M2 in the driving circuit 110 is connected to the ground voltage Vss. An equation (1) and an equation (2) below respectively represents VA and VB in the reset period TS1:

VA=Vdd (1)

VB=Vss (2)

During the scan period TS2, at this time the scan voltage Vscan_n has been increased to the high voltage level, and the previous scan voltage Vscan_n−1 is lowered to the low voltage level. Accordingly, the second switch in the reset circuit 130 is in the turn off state, so as to discontinue providing the reset voltage to the control node of the driving circuit 110. The first switch 140 is in the turn on state, and the first switch 140 transmits the data voltage Vdata received by the first node of the first switch 140 to the compensation circuit 150. Since the third transistor M3 in the compensation circuit 150 is substantially a diode in the forward biased mode, the capacitor C in the memory unit 120 may be discharged through the transistors M3 and M1. Therefore, the control node voltage VA of the driving circuit 110 is equal to the data voltage Vdata added to a threshold voltage Vth_M3 of the third transistor M3 (i.e., Vdata+Vth_M3). An equation (3) and an equation (4) below respectively represents VA and VB in the scan period TS2:

VA=Vdata+Vth_{—}M3 (3)

VB=Vss (4)

At this moment, the second transistor M2 in the driving circuit 110 operates in a saturation mode. Therefore, the driving circuit Iled flowing to the light emitting unit 160 that is generated by the driving circuit 110 is related to a gate-source voltage Vgs and a threshold voltage Vth_M2 of the second transistor M2. The aforesaid gate-source voltage Vgs represents a voltage difference between the gate and the source of the second transistor M2, or VA−VB. The equations (3) and (4) are carried into an equation (5) below to describe a relationship between the driving current Iled, Vgs, and Vth M2, and K is a constant.

$$\begin{matrix}Iled = {K ( Vgs - Vth\_M2 )}^{2} \\ = {K ( V A - VB - Vth\_M2 )}^{2} \\ = {K ( Vdata + Vth\_M3 - Vss - Vth\_M2 )}^{2}\end{matrix} \qquad ( 5 )$$

Since the transistors M1, M2, M3, and M4 are close to each other in the driving device 100, during layout the size of the transistors M1-M4 may be made the same. Consequently, the threshold voltages Vth_M1, Vth_M2, Vth_M3, and Vth_M4 of the transistors M1-M4 are substantially identical, thereby allowing a parameter Vth_M3 and a parameter Vth_M2 in the above equation (5) to cancel each other. Hence, the aforesaid driving current Iled may be further simplified as an equation (6):

Iled=K(Vdata−Vss)² (6)

As shown in equation (6), the driving current Iled is only related to the data voltage Vdata and the ground voltage Vss. As the equation (6) no longer includes parameters such as the power source voltage Vdd or any transistor threshold voltages, the driving current Iled is not restricted by the power source voltage Vdd and the transistor threshold voltages.

The latch period TS3 follows thereafter. During the latch period TS3, the scan signal Vscan_n, the previous scan signal Vscan_n−1, and the data voltage Vdata are set at the low voltage level. At this moment, the first switch 140 and the second switch in the reset circuit 130 are in the turn off state. By using a charge/voltage stored by the capacitor C in the memory unit 120 during the scan period TS2, the control node voltage VA of the driving circuit 110 is maintained during the latch period TS3 (i.e., VA is maintained at a voltage value of Vdata+Vth_M3). The source node voltage VB, as it is connected to the ground voltage Vss, maintains its original voltage value (i.e., VB=Vss). Therefore, an equation of the driving current Iled in the latch period TS3 is identical to the equation (6). In other words, the driving current Iled of the scan period TS2 and the latch period TS3 is the same.

After the latch period TS3, the driving sequence enters the reset period TS1 again. As described above, the control node voltage VA of the driving circuit 110 is reset to the power source voltage Vdd, and the aforesaid operations are repeated. Therefore, in the reset period TS1, the control node voltage VA of the driving circuit 110 is reset, then in the scan period TS2, the control node voltage VA of the driving circuit 110 is configured to Vdata+Vth_M3. Hence, during the scan period TS2 and the latch period TS3, the driving circuit 110 generates the driving current Iled according to the control node voltage VA, and thus the brightness thereof is not altered before the next reset period TS1. As the equation (6) no longer includes parameters such as the power source voltage Vdd or any transistor threshold voltages, the driving current Iled flowing to the light emitting unit 160 does not cause a brightness variation because of differences in the power source voltage Vdd received by each of the pixels as well as in the transistor threshold voltages.

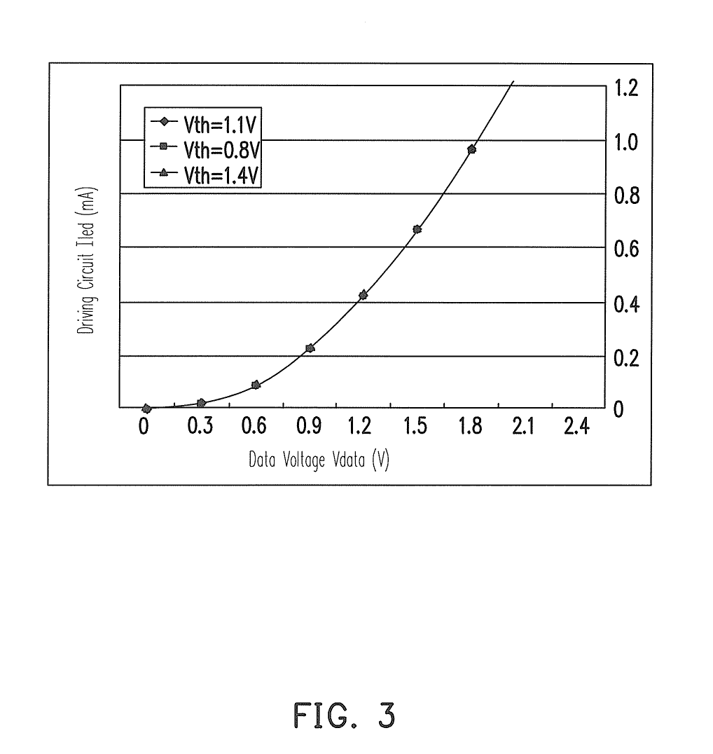

In order to more clearly describe how different transistor threshold voltage values Vth_M2 influence the driving current fled, the driving device 100 is used to illustrate the relationship between the threshold voltage Vth_M2 of the second transistor M2 and the driving current Iled, with references to FIGS. 1-3. FIG. 3 is a characteristic curve of the driving current Iled and the data voltage Vdata of the light emitting unit 150 depicted in FIG. 1 in accordance with the first embodiment of the invention. Assume herein the power source voltage Vdd is 10 V, the ground voltage Vss is 0 V, the scan voltage Vscan at the high voltage level is approximately equal to the power source voltage Vdd, and assume the scan voltage Vscan at the low voltage level is approximately 0 V. A highest voltage level of the data voltage Vdata is approximately 5 V, whereas a lowest voltage level thereof is approximately 0 V.

Here, the threshold voltage Vth_M2 of the second transistor M2 in the driving device 100 is set to 0.8 V, 1.1 V, and 1.4 V. These three conditions are used to respectively test the relationship between the data voltage Vdata and the driving current Iled of the driving device 100, and a test result is illustrated in FIG. 3. In FIG. 3, three curves are used to represent a transistor threshold voltage Vth as 0.8 V (i.e., a curve with connecting rectangular symbols), 1.1 V (i.e., a curve with connecting diamond symbols), and 1.4 V (i.e., a curve with connecting triangular symbols), so as to compare variations of the driving current Iled under different threshold voltages Vth_M2.

As shown by a simulation result depicted in FIG. 3, when the data voltage Vdata is 0 V, the driving current Iled is 0 A, hence the light emitting unit 160 does not emit light. As the data voltage Vdata gradually increases in voltage, the driving current Tied gradually increases its current value because of equation (6). Therefore, the light emitting unit 160 gradually increases in brightness in proportion with the size of the driving current Iled. That is, as the driving current Iled increases, the brightness of the light emitting unit 160 increases. As shown in FIG. 3, the driving current Iled is substantially not affected by the variation of the threshold voltage Vth_M2. The current value of the driving current Iled outputted by the driving device 100 is altered according to the data voltage Vdata.

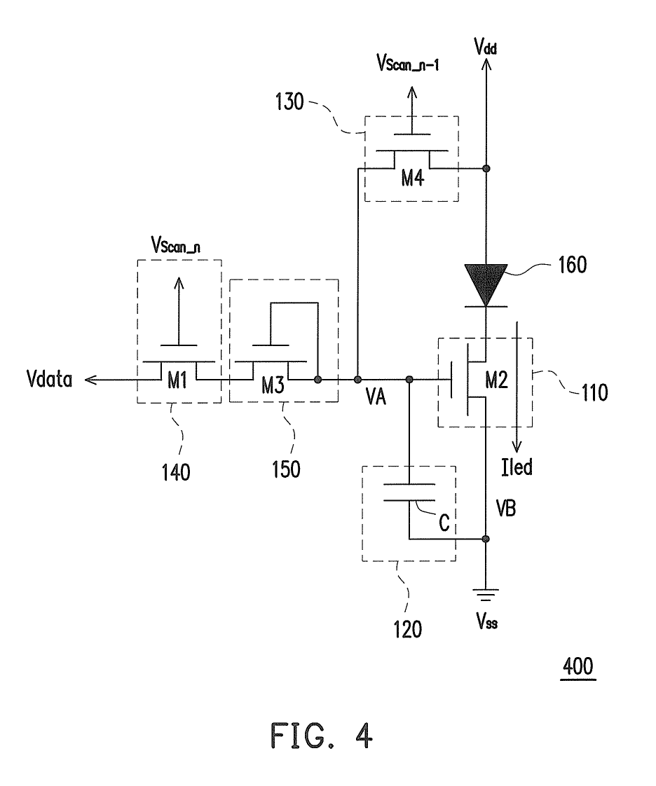

According to the above-described embodiment, the capacitor C in the memory unit 120 is configured to maintain the control node voltage VA of the driving circuit 110. Hence the first node of the capacitor C is connected to the power source voltage Vdd, although the invention is not limited thereto. For example, referring to FIG. 4, in other embodiments of the invention the capacitor c may be connected to the ground voltage Vss. FIG. 4 is an equivalent circuit diagram of a driving device 400 of the light emitting unit 160 in accordance with a second embodiment of the invention. A difference with the driving device 100 of the first embodiment is that, in the present embodiment, the third voltage the second node of the capacitor C in the memory unit 120 receives is the ground voltage Vss. Other details of the present embodiment have been included in the aforesaid first embodiment, which will not be further explained herein.

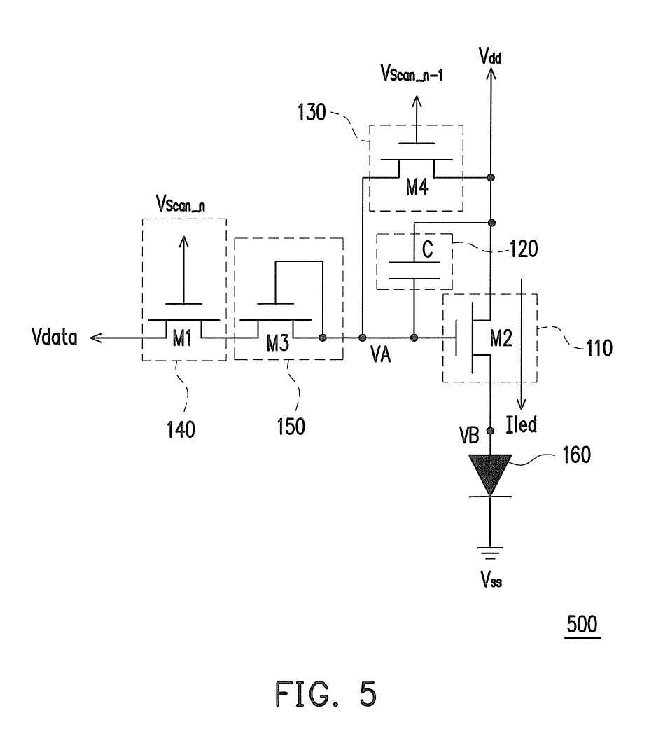

In addition, although the aforesaid embodiment uses the drain node of the second transistor M2 as the drive node of the driving circuit 110, the invention is not limited thereto. For example, FIG. 5 is an equivalent circuit diagram of a driving device 500 of the light emitting unit 160 in accordance with a third embodiment of the invention. A difference with the first embodiment is that, the first node of the second transistor M2 in the driving circuit 110 (i.e., the drain node in the present embodiment) receives the first voltage. In the present embodiment, the first voltage is the power source voltage Vdd. The second node of the second transistor M2 (i.e., the source node in the present embodiment) is used as the drive node of the driving circuit 110, so as to connect to the light emitting unit 160. Other details of the present embodiment have been included in the aforesaid first embodiment, which will not be further explained herein. Assuming the source node voltage VB of the second transistor M2 is Vx V, then an equation (7) may represent the driving current Iled depicted in FIG. 5:

Iled=K(Vdata−Vx)² (7)

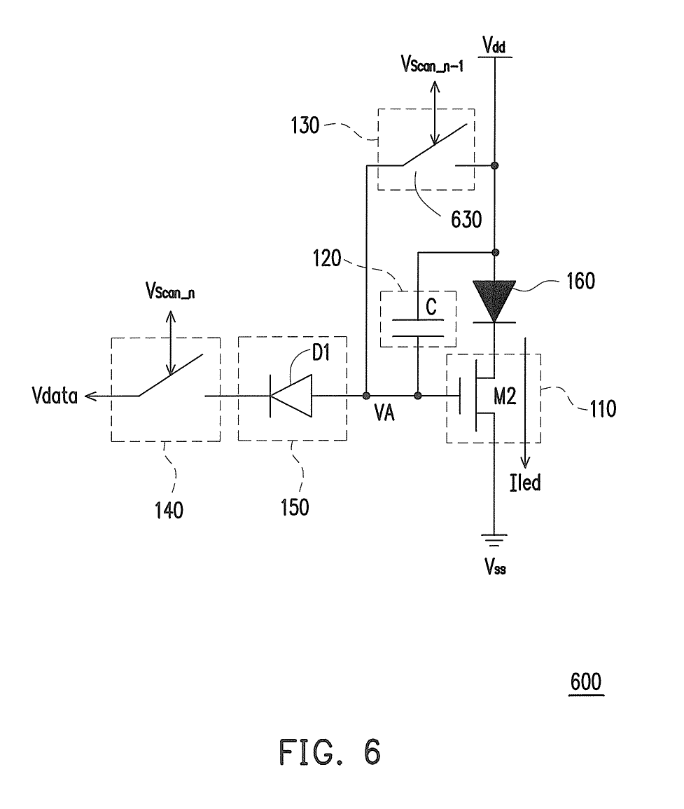

Furthermore, the first switch 120, the second switch in the reset circuit 130, and the compensation circuit 140 adopted by the driving device 100 of the aforesaid light emitting unit 160 are respectively formed by the transistors M1, M4, and M3. In other embodiments of the invention, circuits having equivalent functions may be used to constitute the driving device 100. For example, FIG. 6 is a schematic circuit diagram of a driving device 600 of the light emitting unit 160 in accordance with a fourth embodiment of the invention. Additional reference to both FIGS. 2 and 5 is also requested. A difference with the first embodiment is that, the present embodiment respectively implements the first switch 140, a second switch 630 in the reset circuit 130, and the compensation circuit 150 by using an equivalent switching circuit and a diode D1. Here, the equivalent switching circuit is not limited to a single transistor. An anode of the diode D1 in the compensation circuit 150 is connected to the control node of the driving circuit 110, and another node if the diode D1 is connected to the second node of the first switch 140.

When the driving sequence is at the reset period TS1, the previous scan voltage Vscan_n−1 is converted in advance to the high voltage level, whereas the scan voltage Vscan_n is still at the low voltage level. Thereby, the second switch 630 is turned on, and the first switch 140 is turned off. Therefore, the control node voltage VA of the driving circuit 110 is reset to the power source voltage Vdd. During the scan period TS2, the previous scan voltage Vscan_n−1 is converted to the low voltage level, whereas the scan voltage Vscan_n is boosted to the high voltage level. Thereby, the first switch 140 is turned on, and the second switch 630 is turned off. Therefore, the control node voltage VA is equal to the data voltage Vdata added to a threshold voltage Vth_D1 of the diode D1 in the compensation circuit 150. According to the control node voltage VA at this moment, the driving circuit 110 determines the size of the driving current Iled. Other details of the present embodiment have been included in the aforesaid first embodiment, which will not be further explained herein.

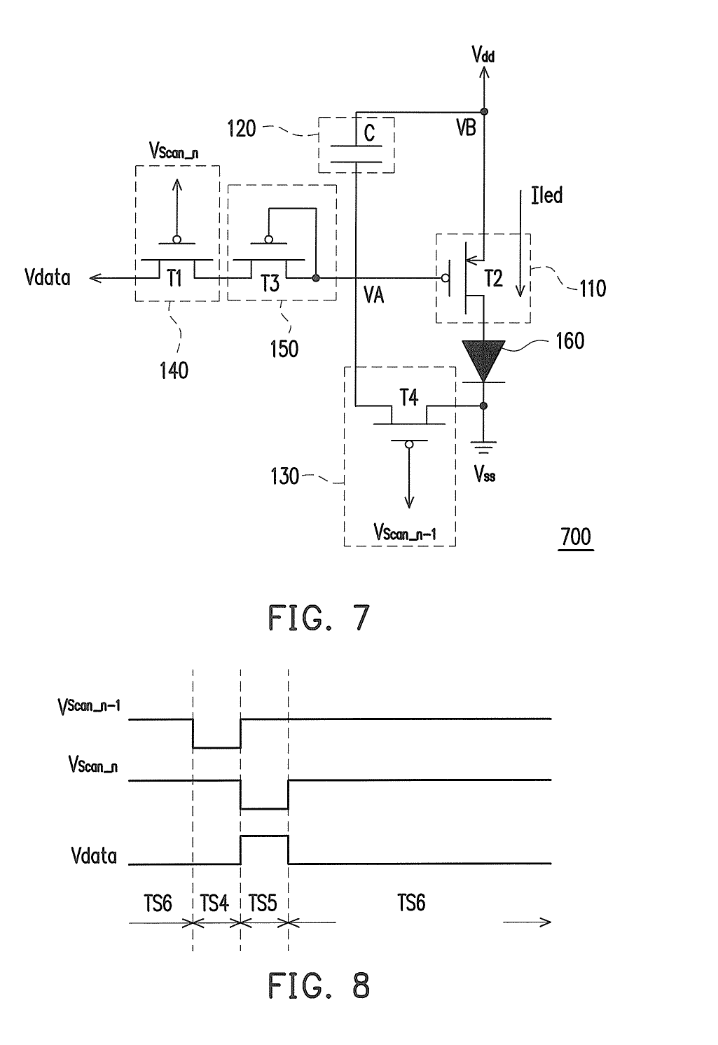

According to the above-described embodiments, the driving circuit 110, the reset circuit 130, the first switch 140, and the compensation circuit 150 adopted by the driving device 100 of the light emitting unit 160 in the present embodiment are all NMOS transistors. However, other implementations may be possible and the invention is not limited thereto. For example, in order to achieve the aforesaid effects, other embodiments of the invention may employ PMOS transistors to constitute the driving device 100. For example, FIG. 7 is an equivalent circuit diagram of a driving device 700 of the light emitting unit 160 in accordance with a fifth embodiment of the invention. FIG. 8 is a drive timing diagram of a driving device 700 depicted in FIG. 7 in accordance with the fifth embodiment of the invention.

Referring to FIGS. 7 and 8, the first switch 140 includes a first transistor T1 having a first node (e.g., a source node) receiving the data voltage Vdata, a second node (e.g., a drain node) connected to the compensation circuit 150, and a control node (e.g., a gate node) connected to the scan voltage Vscan_n.

A second transistor T2 of the driving circuit 110 has a first node (e.g., a source node) connected to the first voltage. In the present embodiment, the first voltage is the power source voltage Vdd. A second node (e.g., a drain node) of the second transistor T2 is used as the drive node of the driving circuit 110, so as to connect to the light emitting unit 160. The compensation circuit 150 includes a third transistor T3 having a first node (e.g., a source node) connected to the second node of the first switch 140, a second node (e.g., a drain node) connected to the control node of the driving circuit 110, and a control node (e.g., a gate node) connected to the second node of the third transistor T3. Therefore, the third transistor T3 acts as a diode having an cathode connected to the control node of the driving circuit 110, and a anode connected to the second node of the first switch 140.

The reset circuit 130 includes the second switch formed in the present embodiment by a fourth transistor T4. The fourth transistor T4 has a first node (e.g., a source node) connected to the second voltage (e.g., the ground voltage Vss), a second node (e.g., a drain node) connected to the control node of the driving circuit 110, and a control node (e.g., a gate node) connected to the previous scan voltage Vscan_n−1. A difference between the driving device 700 and the driving device 100 is that, the first transistor T1, the second transistor T2, the third transistor T3, and the fourth transistor T4 are PMOS transistors.

During a reset period TS4 of the driving sequence depicted in FIG. 8, while the scan voltage Vscan_n is still at the high voltage level, the previous scan voltage Vscan_n−1 is converted in advance from the high voltage level to the low voltage level. Therefore, the first switch 140 is in the turn off state, whereas the second switch in the reset circuit 130 is in the turn on state. Accordingly, the reset circuit 130 resets the control node voltage VA of the driving circuit 110 to the ground voltage Vss, and at this moment the capacitor C in the memory unit 120 discharges its stored internal charges. The source node voltage VB of the second transistor T2 in the driving circuit 110 is connected to the power source voltage Vdd. Below, an equation (8) and an equation (9) respectively represents VA and VB in the reset period TS4:

VA=Vss (8)

VB=Vdd (9)

During a scan period TS5, at this time the scan voltage Vscan_n has been lowered from the high voltage level to the low voltage level, the previous scan voltage Vscan_n−1 is reboosted to the high voltage level, and a voltage value is entered for the data voltage Vdata. Accordingly, the second switch in the reset circuit 130 is in the turn off state, so as to discontinue providing the reset voltage (i.e., the ground voltage Vss in the present embodiment) to the control node of the driving circuit 110. The first switch 140 is in the turn on state, and the first switch 140 transmits the data voltage Vdata received by the first node of the first switch 140 to the compensation circuit 150.

Since the third transistor T3 in the compensation circuit 150 is substantially a diode in the forward biased mode, the data voltage Vdata may charge the capacitor C through the transistors T1 and T3. Therefore, the control node voltage VA of the driving circuit 110 is equal to the data voltage Vdata subtracted by a threshold voltage Vth_T3 of the third transistor T3 (i.e., Vdata−Vth_T3). Below, an equation (10) and an equation (11) respectively represents VA and VB in the scan period TS5:

VA=Vdata−Vth_{—}T3 (10)

VB=Vdd (11)

At this moment, the second transistor T2 in the driving circuit 110 operates in the saturation mode. Therefore, the driving circuit Iled flowing to the light emitting unit 160 that is generated by the driving circuit 110 is related to a source-gate voltage Vsg and a threshold voltage Vth_T2 of the second transistor T2. The aforesaid source-gate voltage Vsg represents a voltage difference between the source and the gate of the second transistor T2, or VB−VA. The equations (10) and (11) are carried into an equation (12) below to describe a relationship between the driving current Iled, Vgs, and Vth_T2, and K is a constant.

$$\begin{matrix}Iled = {K ( Vsg - Vth\_T 2 )}^{2} \\ = {K ( VB - V A - Vth\_T 2 )}^{2} \\ = {K [ Vdd - ( Vdata - Vth\_T3 ) - Vth\_T2 ]}^{2} \\ = {K ( Vdd - Vdata + Vth\_T 3 - Vth\_T 2 )}^{2}\end{matrix} \qquad ( 12 )$$

Since the transistors T1, T2, T3, and T4 are close to each other in the driving device 700, during layout the size of the transistors T1-T4 may be made the same. Consequently, the threshold voltages Vth_T1, Vth_T2, Vth_T3, and Vth_T4 of the transistors T1-T4 are substantially identical, thereby allowing a parameter Vth_T3 and a parameter Vth T2 in the above equation (12) to cancel each other. Hence, the aforesaid driving current Iled may be further simplified into an equation (13):

Iled=K(Vdd−Vdata)² (13)

A latch period TS6 follows thereafter. During the latch period TS6, the scan signal Vscan_n and the previous scan signal Vscan_n−1 are set at the high voltage level. At this moment, the first switch 140 and the second switch in the reset circuit 130 are in the turn off state. By using a charge/voltage stored by the capacitor C in the memory unit 120 during the scan period TS5, the control node voltage VA of the driving circuit 110 is maintained during the latch period TS3 (i.e., VA is maintained at a voltage value of Vdata−Vth_T3). The source node voltage VB, connected to the ground voltage Vss, maintains its original voltage value (i.e., VB=Vss). Therefore, an equation of the driving current Iled in the latch period TS3 is identical to the equation (13). In other words, the driving current Iled of the scan period TS5 and the latch period TS6 is the same.

After the latch period TS6, the driving phase enters the reset period TS4 again. As described above, the control node voltage VA of the driving circuit 110 is reset to the ground voltage Vss, and the aforesaid operations are repeated. Therefore, according to the voltage stored by the capacitor C in the memory unit 120, the driving device 700 of the pixels may generate the driving current Iled for the light emitting unit 160, such that the light emitting unit 160 produces a brightness corresponding to the data voltage Vdata. Other details of the present embodiment have been included in the aforesaid embodiments, which will not be further explained herein.

In light of the foregoing, an embodiment of the invention employs in advance a reset circuit to reset a control node voltage of a driving circuit, then employs a compensation circuit to transmit a data voltage to a control node of the driving circuit. A capacitor is employed to maintain the value of the control node voltage of the driving circuit, such that the driving current generated by the driving circuit is solely correlated with the data voltage and not influenced by a transistor threshold voltage. Thereby, according to substantially equal data voltages, a light emitting unit may achieve an uniform brightness for each of the pixels on a display panel. Moreover, in an embodiment of the invention, a scan voltage of a driving sequence is identical to a scan voltage in a 2T1C circuit configuration, thus saving a design time.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving device of a light emitting unit, comprising:
a driving circuit having a control node and a drive node, the drive node connected to the light emitting unit, wherein the driving circuit determines a current of the drive node in accordance with a voltage of the control node;
a memory unit connected to the control node of the driving circuit, configured to maintain the voltage of the control node of the driving circuit;
a reset circuit connected to the control node of the driving circuit, providing a reset voltage to the control node of the driving circuit during a reset period;
a first switch having a first node receiving a data voltage and a control node receiving a scan voltage; and
a compensation circuit connected between a second node of the first switch and the control node of the driving circuit, configured to transmit the data voltage provided by the first switch to the control node of the driving circuit.

2. The driving device as claimed in claim 1, wherein the compensation circuit does not provide the compensation voltage outside of the reset period.

3. The driving device as claimed in claim 1, wherein the reset voltage is a power source voltage.

4. The driving device as claimed in claim 1, wherein the first switch comprises a first transistor having a first node receiving the data voltage, a second node connected to the compensation circuit, and a control node receiving the scan voltage.

5. The driving device as claimed in claim 4, wherein the first transistor is a N-channel metal oxide semiconductor (NMOS) transistor.

6. The driving device as claimed in claim 1, wherein the driving circuit comprises a second transistor having a first node receiving a first voltage, a second node configured as the drive node of the driving circuit, and a control node configured as the control node of the driving circuit.

7. The driving device as claimed in claim 6, wherein the second transistor is a NMOS transistor.

8. The driving device as claimed in claim 6, wherein the second transistor is a P-channel metal oxide semiconductor (PMOS) transistor.

9. The driving device as claimed in claim 6, wherein the first voltage is the power source voltage.

10. The driving device as claimed in claim 6, wherein the first voltage is a ground voltage.

11. The driving device as claimed in claim 1, wherein the compensation circuit comprises a third transistor having a first node connected to the second node of the first switch, a second node connected to the control node of the driving circuit, and a control node configured as the second node of the third transistor.

12. The driving device as claimed in claim 11, wherein the third transistor is a NMOS transistor.

13. The driving device as claimed in claim 1, wherein the compensation circuit comprises a diode having a cathode connected to the second node of the first switch, and an anode connected to the control node of the driving circuit.

14. The driving device as claimed in claim 1, wherein the reset circuit comprises a second switch having a first node connected to a second voltage, a second node connected to the control node of the driving circuit, and a control node receiving a previous scan voltage.

15. The driving device as claimed in claim 14, wherein the second switch comprises a fourth transistor having a first node connected to the second voltage, a second node connected to the control node of the driving circuit, and a control node receiving the previous scan voltage.

16. The driving device as claimed in claim 15, wherein the fourth transistor is a NMOS transistor.

17. The driving device as claimed in claim 1, wherein the memory unit comprises a capacitor having a first node connected to the control node of the driving circuit, and a second node receiving a third voltage.

18. The driving device as claimed in claim 17, wherein the third voltage is the power source voltage.

19. The driving device as claimed in claim 17, wherein the third voltage is the ground voltage.

20. The driving device as claimed in claim 1, wherein the light emitting unit is a light emitting diode.

21. The driving device as claimed in claim 1, wherein the light emitting unit is an organic light emitting diode.

22. The driving device as claimed in claim 1, wherein the light emitting unit and the driving device are configured in a pixel of a display panel.
